(19) United States
(12) Patent Application Publication
(10) Pub. No.: US 2009/0217107 A1
(43) Pub. Date: Aug. 27, 2009

(54) Method and Device for Data Processing

(75) Inventors: Wolfgang Pfeiffer, Grossbottwar (DE); Reinhard Weiberle, Vaihingen/Enz (DE); Bernd Mueller, Leonberg-Silberberg (DE); Florian Hartwich, Reutlingen (DE); Werner Harter, Illingen (DE); Ralf Angerbauer, Schwieberdingen (DE); Eberhard Boehl, Reutlingen (DE); Thomas Kottke, Ehningen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/988,847

(22) PCT Filed: Jul. 26, 2006
(86) PCT No.: PCT/EP2006/064670

§ 371 Date: Mar. 5, 2009

(30) Foreign Application Priority Data
Aug. 8, 2005 (DE) 10 2005 037 233.3

(51) Int. Cl. G06F 15/76; G06F 9/06; G06F 11/07

(52) U.S. Cl. 714/48; 712/29; 712/E09.003; 714/E11.025

(57) ABSTRACT

A method and device for data processing having at least three identical or similar execution units, wherein at least one comparator exists and at least two execution units are grouped such that the output signals of the at least two execution units are connected with the at least one comparator and compared.

### BACKGROUND INFORMATION

Today, dual-core μC architectures are already implemented in various places, or their implementation is planned. In principle, two variants can be distinguished in this context.

Implementation in the lockstep mode: This is intended primarily for applications having high error-detection requirements, for example, safety-relevant applications. Both cores process the same job simultaneously. A comparator unit checks whether the two results are identical, and in the “good” case relays the result. In the case of an error, an error signal is generated.

Implementation in a performance mode: In this case, the two cores work largely independently of each other. In particular, they process different jobs at the same time and can consequently provide a higher computing power. This concept has been announced and implemented by various manufacturers of semi-conductors, and is considered to be one of the main means of the future for increasing performance.

Multi-core architectures are discussed in many scientific publications, primarily with regards to the aspect of the possibility of parallelization (performance improvement).

With declining costs for individual cores, it is possible to integrate considerably more than two cores in one processor even in very cost-sensitive applications.

### SUMMARY

An objective of the present invention is to interconnect the existing execution units in a multiprocessor system such that both the error-detection jobs and the jobs designed for performance may be executed. An advantage of the present invention is that both jobs requiring high error-detection properties of the computing system and jobs requiring high performance may be executed on the same computing system.

As the level of technology advances, the cost of a processing unit is becoming lower and lower compared to a memory. Providing multiple cores is therefore technically practical and is also already used in practice, but until now in particular with the desire for increased performance. The structures presented here offer multiple permanently interconnected configurations that may be implemented for various jobs, depending on the requirement.

An example data-processing device having at least three identical or similar execution units is advantageously included, wherein at least one comparator exists and at least two execution units are grouped such that the output signals of the at least two execution units are connected to the at least one comparator.

An example device is advantageously included, wherein the comparator is designed such that it forms an output signal from the output signals of the execution units in accordance with a specifiable rule.

An example device is advantageously included, wherein the comparator is designed such that it generates at least one error message as a function of the result of the comparison.

An example device is advantageously included, wherein the comparator is designed such that it outputs at least one status signal as a function of the result of the comparison.

An example device is advantageously included, wherein the comparator is designed such that it outputs at least one status signal as a function of the result of the comparison, and this signal contains a first identifier.

An example device is advantageously included, wherein the comparator is designed such that it outputs at least one status signal as a function of the result of the comparison, this signal contains a first identifier, and a decision regarding the further processing of the output signals is made as a function of this first identifier.

An example device is advantageously included, wherein an arrangement is provided that distribute the data-processing jobs that are to be processed to the included execution units or groups of execution units as a function of a second identifier of these data-processing jobs.

An example method for data processing in a device having at least three identical or similar execution units and at least one comparator is advantageously described, wherein the output signals of at least two execution units are compared by comparator.

An example method is advantageously described, wherein the at least one comparator forms, according to a specifiable rule, an output signal from the output signals of the at least two execution units.

An example method is advantageously described, wherein the at least one comparator generates at least one error message as a function of the result of the comparison of the output signals of the at least two execution units.

An example method is advantageously described, wherein the at least one comparator outputs at least one status signal as a function of the result of the comparison of the output signals of the at least two execution units.

An example method is advantageously described, wherein the at least one comparator generates at least one status signal as a function of the result of the comparison of the output signals of the at least two execution units, and this signal contains a first identifier.

An example method is advantageously described, wherein the first identifier of the status signal is formed as a function of the error message of the comparator or contains this error message.

An example method is advantageously described, wherein the first identifier of the status signal is formed as a function of the specifiable rule for generating the output signals of the at least one comparator or contains this rule.

An example method is advantageously described, wherein the at least one comparator generates at least one status signal as a function of the result of the comparison of the output signals of the at least two execution units, and this signal contains a first identifier, and as a function of this identifier a decision is made regarding the further processing of the output signals.

An example method is advantageously described wherein the data-processing jobs to be processed are distributed, as a function of a second identifier of these data-processing jobs, to the at least three execution units or groups of execution units.

### BRIEF DESCRIPTION OF THE DRAWINGS

FIG. 1 shows a multiprocessor system having three execution units.

FIG. 2 shows a multiprocessor system having four execution units.

FIG. 3 shows a multiprocessor system having four execution units.

FIG. 4 shows a multiprocessor system having five execution units.

### DETAILED DESCRIPTION OF EXAMPLE EMBODIMENTS

In the following, “execution unit” may denote a processor/core/CPU, as well as an FPU (floating point unit), a DSP (digital signal processor), a co-processor or an ALU (arithmetic logical unit).

The present invention concerns multiprocessor systems having at least three execution units. In this context, the execution units are interconnected such that both jobs requiring strong error detection, an error tolerance by the executing hardware units, as well as jobs that primarily place requirements on performance or do not require error detection or error tolerance may be processed. For this purpose, the pending jobs may be distributed to the different execution units in this multiprocessor system in accordance with their requirements. In this context, the distribution to the different execution units may occur statically or also during operation. To that end, an identifier may be assigned to the jobs or operating system objects, the identifier indicating which requirement they have of the error detection or error tolerance. In this case, an operating system may then distribute the jobs to the respectively available execution units.

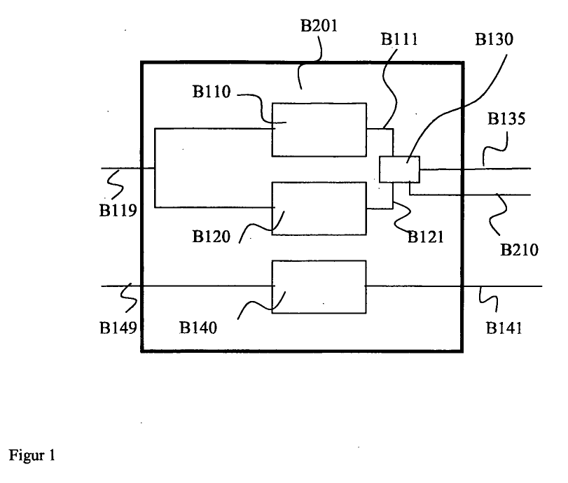

FIG. 1 shows a specific embodiment of a multiprocessor system B201 having three execution units B110, B120, and B140, B110 and B120 working in a compare mode and their outputs B111 and B121 being compared to each other in a comparator B130. The output B135 is the output signal of the comparator, to which signal one of the two signals B111 or B121 is connected in the case of a valid comparison. If an inconsistency is detected between B111 and B121, then output B135 is blocked, deactivated, or switched to inactive. Additionally, a one-value or multi-value status signal B210 may be output. The following refers always to a multi-value status signal, even for the additional exemplary embodiments; this also includes the possibility of a one-value status signal. Execution unit B140 supplies output signal B141 without comparing it and without otherwise checking its validity.

The multiprocessor system is consequently in a position to generate the relevant output signals B210 or B141 in a redundant or a non-redundant way, based on the distribution of the jobs, tasks, or processes to input signals B119 or B149 and thereby to the connected execution units. The distribution thus occurs in the described way, statically or dynamically.

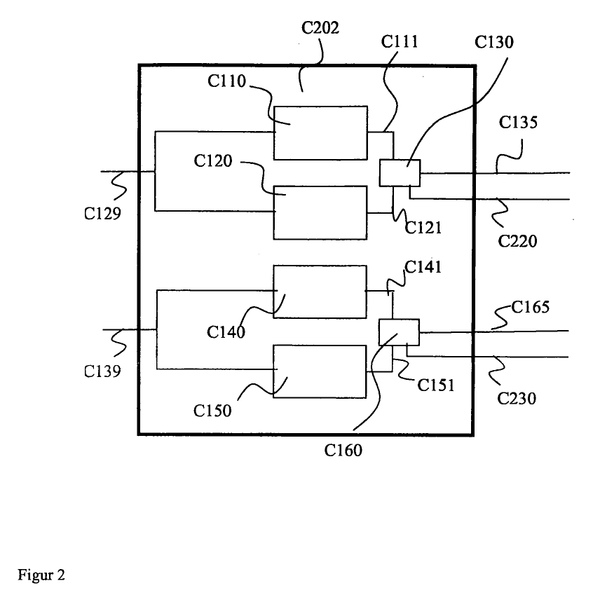

FIG. 2 shows a specific embodiment of a multiprocessor system C202 having four execution units C110, C120, C140, and C150. This multiprocessor system may process two jobs, tasks, or processes simultaneously, the processing of the input signals C129 into the output signals C135, and from C139 into C165. The generation of signal C135 occurs analogously to signal B135, shown in FIG. 1, in the event of a valid comparison of C111 and C121. Multi-value status signal C220 indicates a deviation between these two signals. The second part of the multiprocessor system is structured analogously, having input signals C139 and output signals C141 and C151 of the two execution units C140 and C150. Comparator unit C160 supplies a valid output signal C165 only when the signals C141 and C151 are identical. Multi-value signal C230 indicates the status. In this structure C202, the processing of all jobs is equivalent, since both execution units C110 and C120 and execution units C140 and C150 have the same degree of error detection.

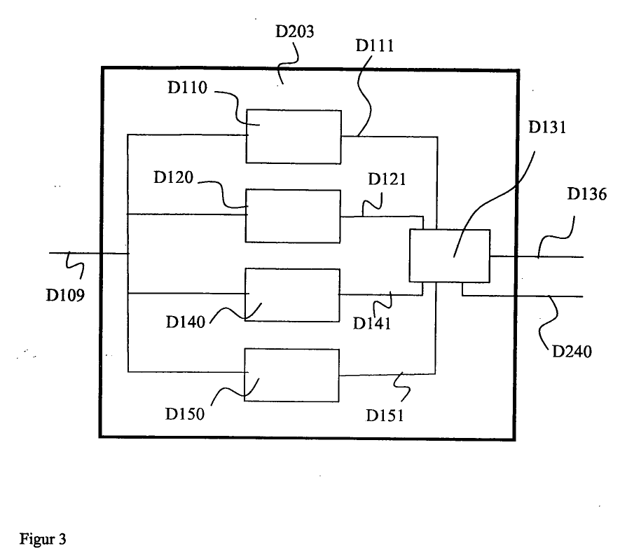

FIG. 3 shows an additional specific embodiment of a multiprocessor system D203 having four execution units D110, D120, D140, and D150, which system performs simultaneously only a processing of the jobs, tasks, or processes pending in input signal D109 to form output signal D136. To that end, signals D111, D121, D141, and D151 are compared to each other in comparator unit D131. In this context, a simple comparison of the output signals may be performed, or one using a specifiable algorithm. This may involve a majority decision, i.e., voting; the signals may be averaged; or a specifiable deviation between the two signals may be tolerated. This output value obtained from the specifiable algorithm is then output as D136. In this context, D240 indicates a multi-value status signal that may indicate not only an error, but also the type of deviation, such as the number of identical signals or the degree of deviation. If the specified algorithm cannot emit an output signal that is correct in terms of the algorithm, then this information may also be emitted by multi-value status signal D240. The output signal may then be deactivated, interrupted, or ignored.

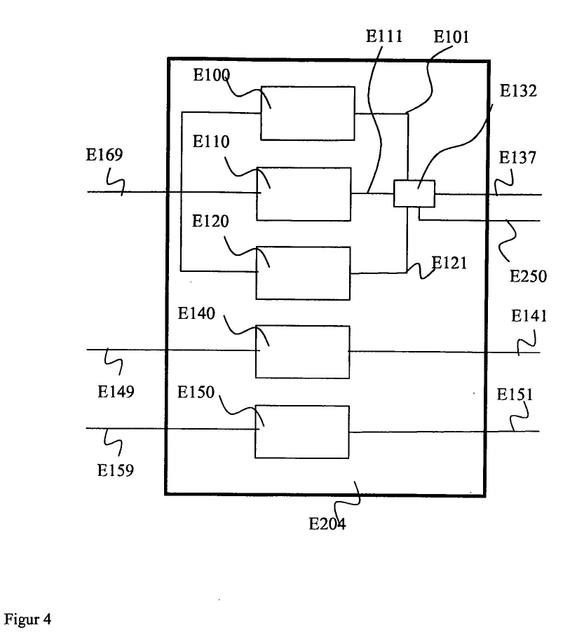

Finally, FIG. 4 shows a specific embodiment of a multiprocessor system E204 having five execution units E100, E110, E120, E140, and E150. Of these, three execution units E100, E110, and E120 are permanently interconnected for comparing input signal E169. The comparison algorithm for input signals E101, E111, and E121 is preset in this instance for comparator E132. The result is emitted as output signal E137, and additionally a multi-value status signal is emitted as E250. Execution units E140 and E150 process in parallel to this input signals E149 and E159, respectively, and generate thereby output signals E141 and E151 without comparison.

1-16. (canceled)

17. A device for data processing, comprising:
at least three identical or similar execution units;
at least one comparator, at least two of the execution units being grouped such that output signals of the at least two execution units are connected to the at least one comparator.

18. The device as recited in claim 17, wherein the comparator is adapted to an output signal from the output signals of the execution units according to a specifiable rule.

19. The device as recited in claim 17, wherein the comparator is adapted to generate at least one error message as a function of a result of the comparison.

20. The device as recited in claim 17, wherein the comparator is adapted to output at least one status signal as a function of a result of the comparison.

21. The device as recited in claim 17, wherein the comparator is adapted to output at least one status signal as a function of the result of the comparison, the status signal containing a first identifier.

22. The device as recited in claim 17, wherein the comparator is adapted to output at least one status signal as a function of a result of the comparison, the status signal containing a first identifier, and as a function of the first identifier, the device makes a decision regarding further processing of the output signals.

23. The device as recited in claim 17, further comprising:
a distributor adapted to distribute data-processing jobs to be processed to the execution units as a function of a second identifier of the data-processing jobs.

24. A method for data processing in a device having at least three identical or similar execution units and at least one comparator, comprising:
comparing output signals of at least two of the execution units using the comparator.

25. The method as recited in claim 24, further comprising:
forming, by the at least one comparator, an output signal from the output signals of the at least two execution units according to a specifiable rule.

26. The method as recited in claim 24, further comprising:
generating, by the at least one comparator, at least one error message as a function of a result of the comparison of the output signals of the at least two execution units.

27. The method as recited in claim 24, further comprising:
outputting, by the at least one comparator, at least one status signal as a function of a result of the comparison of the output signals of the at least two execution units.

28. The method as recited in claim 24, further comprising:
generating, by the at least one comparator, at least one status signal as a function of a result of the comparison of the output signals of the at least two execution units, the signal containing a first identifier.

29. The method as recited in claim 28, wherein the first identifier of the status signal is formed as a function of an error message of the comparator or contains the error message.

30. The method as recited in claim 28, wherein the first identifier of the status signal is formed as a function of a specifiable rule for generation of output signals of the at least one comparator, or contains the rule.

31. The method as recited in claim 24, further comprising:
generating, by the at least one comparator, at least one status signal as a function of a result of the comparison of the output signals of the at least two execution units, the signal containing a first identifier, and, as a function of the identifier, a decision is made regarding further processing of the output signals.

32. The method as recited in claim 24, further comprising:
distributing data-processing jobs to be processed as a function of a second identifier of the data-processing jobs, to the at least three execution units.
